(19) United States
(12) Patent Application Publication
(10) Pub. No.: US 2008/0252591 A1
(43) Pub. Date: Oct. 16, 2008

(54) Distributing and Driving Light Sources of Backlights

(75) Inventors: Henricus Marie Peeters, Eindhoven (NL); Renatus Willem Clemens Van Der Veeken, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 12/092,989

(22) PCT Filed: Nov. 3, 2006
(86) PCT No.: PCT/IB2006/054079

§ 371 Date: May 8, 2008

(30) Foreign Application Priority Data
Nov. 14, 2005 (EP) 05110678.9

(51) Int. Cl. G09G 3/36; F21V 33/00

(52) U.S. Cl. 345/102; 362/234

(57) ABSTRACT

The present invention relates to a backlight for a display device comprising at least a first light source arrangement (1) and a second light source arrangement (2) and drivers for controlling said light source arrangements. The backlight further comprises a third light source arrangement (3), wherein each one of the first and second light source arrangements (1, 2) is controlled by a respective driver (5, 6) such that luminance of the first and second light source arrangements (1, 2) are individually controllable, wherein each of the first and second light source arrangements (1, 2) is controlled such that luminance profile of the first and second arrangements (1, 2) is arranged to approximate at least a portion of a luminance profile of the third light source arrangement (3).

The present invention relates to a backlight for a display device comprising at least a first light source arrangement and a second light source arrangement and drivers for controlling said light source arrangements. The invention further relates to a display device comprising the backlight, driver means for a backlight of a display device and a method of driving a backlight for a display device.

A backlight is a light source arrangement that is placed behind or at a side of a display, such as a liquid crystal display (LCD), to illuminate the display and make displayed information visible. A backlight is particularly favorable under poor lighting conditions. Today, there exist many types of backlights, such as backlights using white light sources or red/green/blue light sources. Several different types of light sources are used in backlights, for example light emitting diodes (LEDs), hot cathode fluorescent lamps (HCFLs) and cold cathode fluorescent lamps (CCFLs). Some backlights comprise small light bulbs arranged along an edge of a display device, and are hence unevenly distributed over the display. Other backlights may comprise light sources, which may be evenly distributed over the entire display area.

Backlights of display devices are, for example, known from published US patent application US 2002/007091, which discloses a backlight for an LCD comprising an array of LEDs and LED drive and control circuitry. The luminance of the backlight is provided by the array of LEDs. The backlight may be driven and controlled by a fast pulse power converter, thus providing a response time for the backlight in the order of microseconds. The backlight may thus, for instance, be used for displaying images provided by a video signal input to the LCD. Furthermore, by separately adjusting the average light output of the red, green and blue LEDs, the color content of the LED backlight may be varied. The light output (luminance) of the red, green and blue LEDs may be independently controlled by separate controllers.

In published Japanese patent JP2005070228, there is disclosed a backlight, provided at the rear of a display, which backlight creates a light emitting surface being composed of a plurality of areas that illuminate independently of each other. In this manner, the disclosed backlight provides a blinking technique capable of eliminating display blurs and flicker. A problem of this backlight is that luminance profile differences between different light sources of the backlight interfere with the image being displayed.

In a hybrid backlight, combining red LEDs with fluorescent lamps in green and blue, the differences in luminance profile between the LEDs and the fluorescent lamps cause color inhomogeneities. These color inhomogeneities present a disadvantage of the hybrid backlights.

An object of the present invention is to reduce color inhomogeneities associated with hybrid backlights.

Another object of the present invention is to reduce differences in luminance profile of different light source arrangements comprised in a display device backlight.

These and further objects are met by the device as set forth in the appended independent claim 1. Specific embodiments are defined in the dependent claims.

According to an aspect of the invention, there is provided a backlight for a display device comprising at least a first light source arrangement and a second light source arrangement and drivers for controlling the light source arrangements. The backlight further comprises a third light source arrangement. Each one of the first and second light source arrangements is controlled by a respective driver such that luminance of the first and second light source arrangements are individually controllable. The first and second light source arrangements are individually controlled such that luminance profile of the first and second arrangements can be approximated with at least a portion of luminance profile of the third light source arrangement.

The luminance profile of a light source may be defined as the luminance of the light source as a function of form and shape of the light source. For example, the luminance at the center of a circular (or spherical) light source is usually greater than the luminance at the periphery of such a light source, i.e. luminance decreases with increasing radius. Thus, the luminance profile may be approximated with a function, which is declining from the center towards the periphery of the light source. Further, the luminance profile of a set of light sources relates to overall luminance of the light source set. It should be noted that a light source arrangement may comprise one single light source as well as a plurality of light sources. Additionally, an overall luminance profile of a light source arrangement comprising a plurality of light sources may be arranged to be controlled such that it approximates the luminance profile of a light source arrangement comprising one single light source.

An idea of the invention is to provide a display device backlight, which comprises at least a first and a second light source arrangement comprised in the backlight, such that the first and second light source arrangements may be controlled to approximate luminance of a third light source arrangement comprised in the backlight. Further, the luminance of each light source arrangement is controlled by means of a separate driver, i.e. each driver is associated with at least one light source arrangement comprised in the backlight. The luminance profile of the third light source arrangement is approximated as follows. Luminance of the first light source arrangement and the second light source arrangement are associated with a first and a second portion, respectively, of the luminance profile of the third light source arrangement. The luminance of the first light source arrangement may then be controlled to provide a local approximation of the first portion of the third light source arrangement. Similarly, the luminance of the second light source arrangement may be controlled to provide a local approximation of the second portion of the third light source arrangement. Consequently, the luminance of the first and second light source arrangements create an overall luminance profile, which approximates the luminance profile of the third light source arrangement. In practice, a large number of light sources are employed to approximate the luminance profile of a light source arrangement. For instance, a set of LEDs are employed to approximate luminance profile of one HCFL.

In a first embodiment of the invention, the first and the second light source arrangement comprise a plurality of light sources, and at least one light source comprised in the first light source arrangement is interspersed with light sources comprised in the second light source arrangement, whereby a gradual luminance transition from the first light source arrangement to the second light source arrangement is achieved, when the first light source arrangement is arranged to have different luminance than the second light source arrangement. Interspersion of the light sources is employed to blur edges that may occur between light source arrangements having different luminance. The interspersion provides a smooth luminance transition between adjacent light source arrangements, which as above are arranged to have different luminance. A light source is, for example, considered to be interspersed with other light sources when all neighboring light sources belong to one or more other light source arrangements. A further example of interspersion is, when every other light source arranged in a row is associated with the first and the second light source arrangement, respectively. An advantage with the interspersion implemented in this embodiment is that borders between light source arrangements are dimmed and a gradual transition in luminance from one light source arrangement to another light source arrangement is achieved.

In a second embodiment, there is provided a display device backlight, in which the first and second light source arrangements are arranged to have a first color and the third light source arrangement is arranged to have a different color than the first color. Advantageously, the color content of the light emitted by the backlight for a display device can be controlled by varying the ratio of light emitted by the first and second light source arrangement to light emitted by the third light source arrangement.

Further, the backlight for a display device is divided into zones, wherein the first light source arrangement is arranged to correspond to a first zone and the second light source arrangement is arranged to correspond to a second zone. The first zone is formed as a quadrangle, particularly a rectangle, and the second zone is arranged to be formed as a quadrangle, particularly a rectangle, that surrounds, the first zone. Preferably, the first zone is concentric with the second zone. The light sources of the second zone are hence located outside the first zone, in the area that is enclosed by the rectangle forming the second zone. Additionally, the quadrangles may have rounded corners. Advantageously, this arrangement allows for compensating differences in luminance profile between two light source arrangements in the horizontal as well as vertical direction.

In another embodiment of the backlight for a display device according to the invention, light sources of the first and second light source arrangements are arranged in a row. It is advantageous to arrange the first and the second light source arrangements in a row when the luminance profile to be matched is extending along the same row. Further, the row may comprise additional light source arrangements such that the overall luminance profile of the light source arrangements is represented by a larger number of local luminance approximations (each luminance approximation originating from a separate light source arrangement). In this manner, a more flexible approximation of the luminance profile of the third light source arrangement may be achieved.

Furthermore, each row of light source arrangements or light sources comprises the same number of light source arrangements or light sources, whereby the backlight for a display device may be controlled by a row-column-addressing technique. Advantageously, each light source or light source arrangement may be controlled by two parameters (a row dimming factor and a column dimming factor). The columns in a row have a common row-dimming factor and the actual luminance profile matching for that row is controlled by the column dimming factors of each respective column. Hence, the row dimming factor provides a base luminance level and the column dimming factors may be varied such that a given luminance profile can be matched. Since many rows have a similar shape in their luminance profiles, but may be slightly offset with respect to their base luminance levels, only the row dimming factors need to be varied such as to change the base luminance level and the column dimming factors may be reused. On the other hand, in cases where rows have the same base luminance level, the row dimming factors may be reused. In this manner, the size and complexity of the control electronics may be reduced. The row and column dimming factors may be stored in a look-up table.

Additionally, the dimming factors may be controlled by feedback from a sensor, such as a light or temperature sensor. As an example, the temperature at the first light source arrangement may be different from the temperature at the second light source arrangement. When the luminance profile of the light source arrangements are affected by the temperature it is not possible to use a look up table. Instead, the row and column dimming factors may be controlled by a signal from the temperature sensor.

Furthermore, light source arrangements that are controlled to emit light of the same (or similar) luminance (in order to approximate a given luminance profile) may be connected to the same driver. As a result, the total number of drivers are reduced.

Moreover, the light source arrangements may comprise light emitting diodes (LEDs), hot cathode fluorescent lamps (HCFLs), cold cathode fluorescent lamps (CCFLs) or a combination thereof. In an embodiment of the present invention, the backlight for a display device may be a hybrid backlight, which for instance may comprise LEDs as well as HCFLs. A hybrid backlight may preferably be used in combination with an LCD. Advantageously, the backlight for a display device according to another embodiment of the invention comprises LEDs and HCFLs, wherein the LEDs are arranged to emit red light and the HCFLs are arranged to emit green and blue light. With this configuration, the low power properties of the green and blue HCFLs are combined with the low power properties of the red LEDs in a preferred manner. The HCFLs may be located between the LEDs as described below or, alternatively, the HCFLs may be located on top of the LEDs.

Further features of, and advantages with, the present invention will become apparent when studying the appended claims and the following description. Those skilled in the art realize that different features of the present invention may be combined to create embodiments other than those described in the following, without departing from the scope of the present invention.

Further aspects according to the invention relate to a display device comprising the backlight, driver means for the backlight of a display device and a method of driving the backlight for a display device as defined in the claims.

The various aspects of the invention, including its particular features and advantages, will be readily understood from the following detailed description and the accompanying drawings, in which:

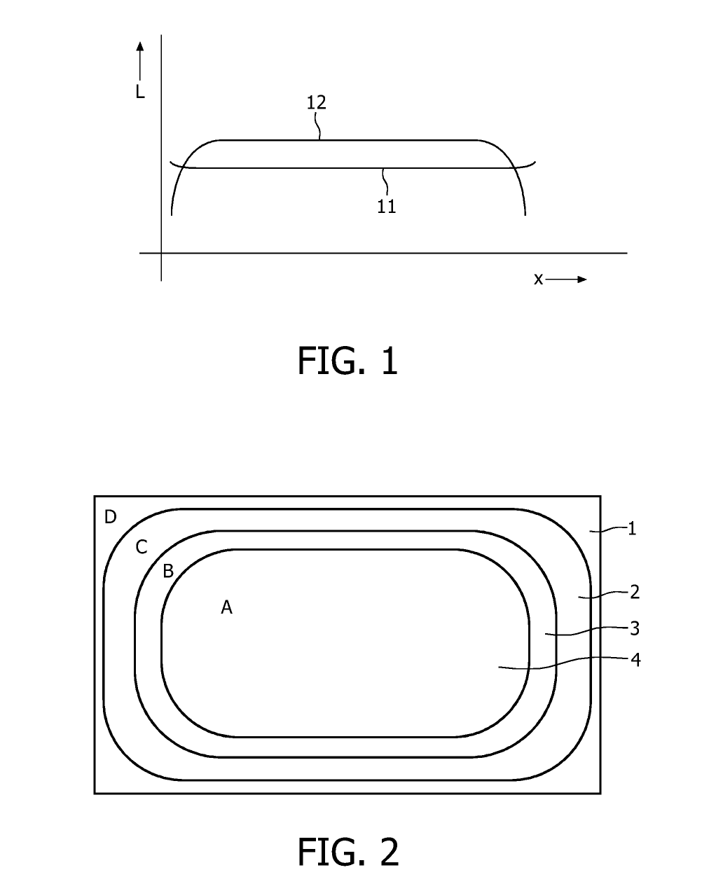

FIG. 1 shows a luminance profile of a group of LEDs and a lamp, respectively;

FIG. 2 is a top view of a backlight being divided into zones according to an embodiment of the invention;

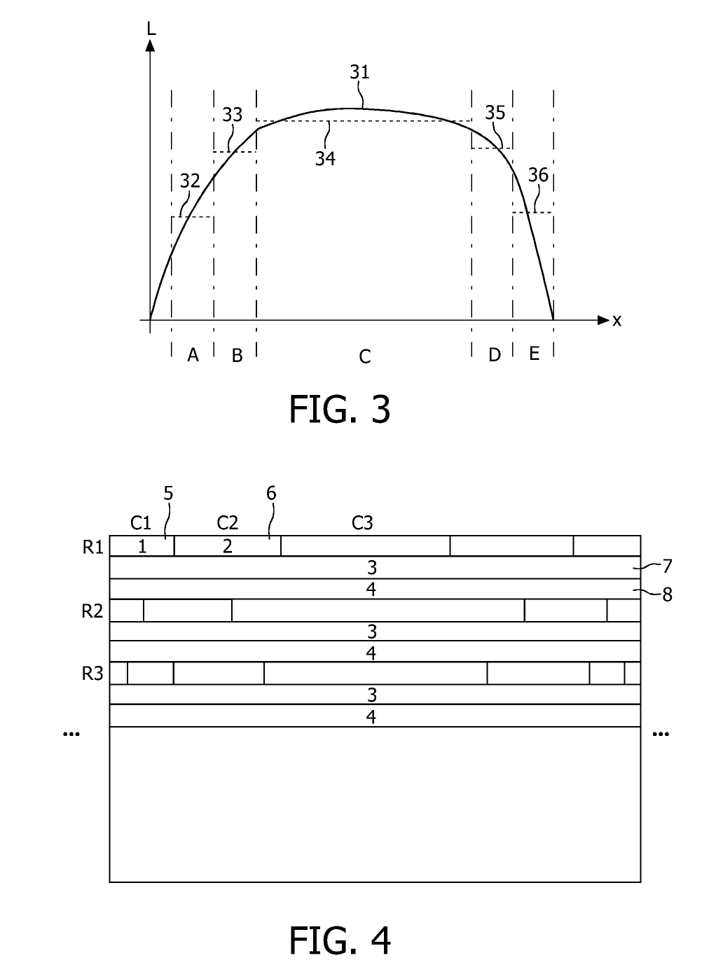

FIG. 3 shows a first graph of a luminance profile and a second graph, which is an approximation of the first graph;

FIG. 4 shows a backlight, which is divided into zones according to another embodiment of the invention;

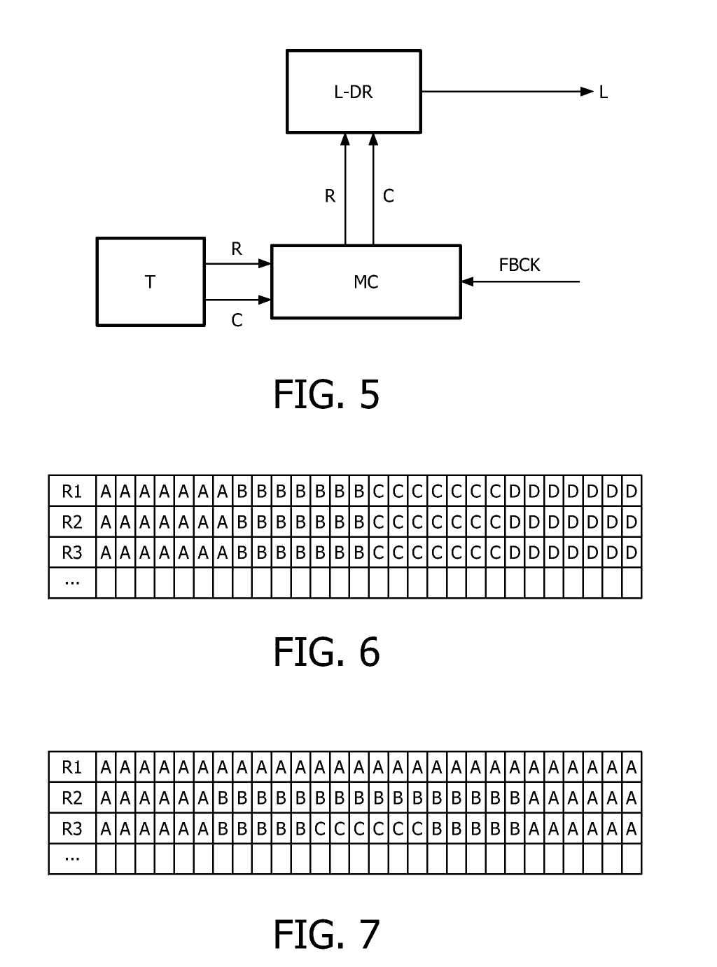

FIG. 5 is a block diagram, showing control and driver circuitry for controlling light sources comprised in zones;

FIG. 6 shows an LED configuration of a backlight according to an embodiment of the invention;

FIG. 7 shows an LED configuration of a backlight according to another embodiment of the invention;

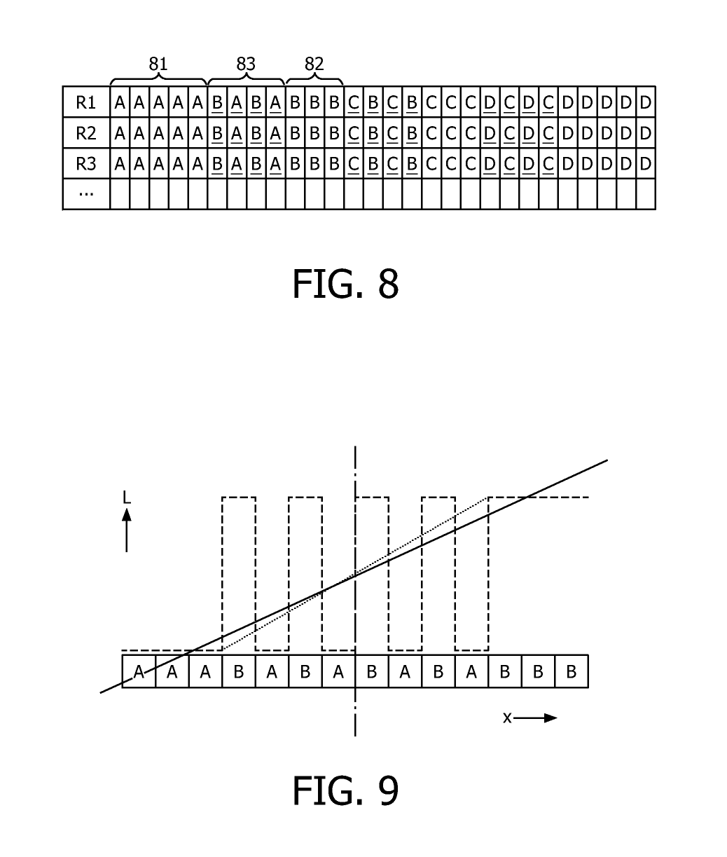

FIG. 8 shows an LED configuration, in which interspersion is implemented, of a backlight according to a further embodiment of the invention;

FIG. 9 shows two graphs of the luminance of a portion of the backlight according to the embodiment of FIG. 8.

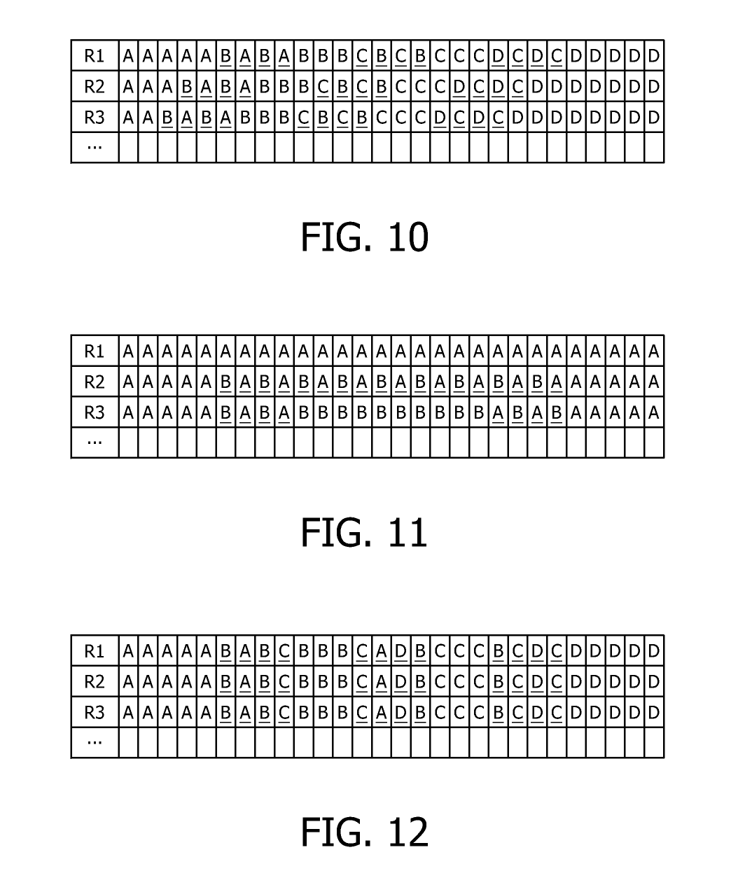

FIG. 10 shows an LED configuration, in which interspersion is implemented, of a backlight according to yet a further embodiment of the invention; and

FIG. 11 shows an LED configuration, in which interspersion is implemented, of a backlight according to another embodiment of the invention.

FIG. 12 shows an LED configuration, in which interspersion is implemented, of a backlight according to a still further embodiment of the invention;

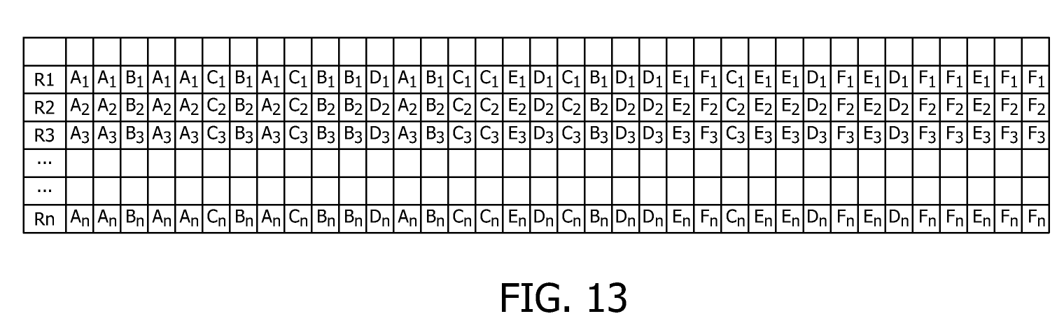

FIG. 13 shows an LED configuration, in which interspersion is implemented, of a backlight according to a further embodiment of the invention; and

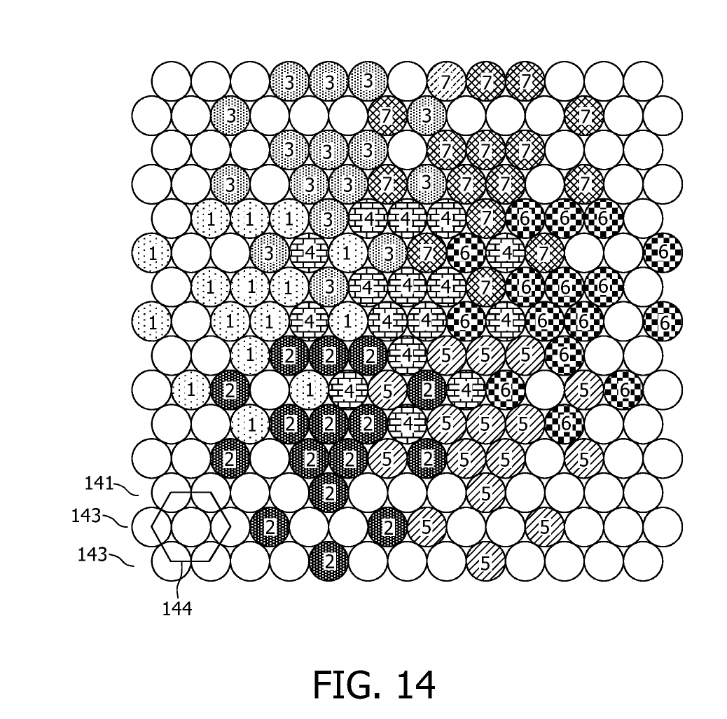

FIG. 14 shows an LED configuration, in which an interspersion is implemented, of a backlight according to yet another embodiment of the invention.

In FIG. 1, there is illustrated two different luminance profiles; one (denoted 11) is associated with a group of LEDs that are arranged in alignment along a given direction and the other (denoted 12) is associated with a fluorescent lamp such as an HCFL, which lamp extends in the same given direction and has a length which is substantially the same as the length of the group of LEDs. The respective luminance profile is represented by luminance L of the respective light source (or group of lights sources) as a function of its spatial extension x in the given direction. In FIG. 1, it can be seen that when moving in the direction of any one of two end points—i.e. along the spatial extension x—of the group of LEDs and the lamp, respectively, the luminance profile 11 of the LEDs deviates from the luminance profile 12 of the lamp. At the respective end point of the spatially extending lamp, the luminance decreases, while in the case of the group of LEDs, overall luminance is relatively constant irrespective of direction of extension. It can be concluded from FIG. 1 that in the case a fluorescent lamp is arranged adjacent to a group of LEDs in e.g. a display backlight, color inhomogeneities (also referred to herein as “color clouds”) appear at a physical location where the luminance profiles deviate from each other.

Now referring to FIG. 2, there is shown a top view of a backlight for a display device according to an embodiment of the invention. The backlight is divided into zones A, B, C and D. For each zone A, B, C and D there is one respective driver 1, 2, 3 and 4, which controls the LEDs in the corresponding zone. Further, the backlight for a display device according to this embodiment comprises HCFLs, as shown in FIG. 4 and discussed in connection thereto. In this embodiment of the invention, the zones are arranged as concentric rectangles, having rounded corners, whereby the luminance of the LEDs in zones provides an approximation of the luminance profile from HCFLs, comprised in the display device backlight. The HCFLs are arranged to emit green and blue light. In this embodiment, the zones are arranged as concentric rectangles, having rounded corners, whereby the LEDs in zones provides an approximation of the luminance profile from the HCFLs.

In FIG. 3, there is illustrated a first graph 31 of a luminance profile of a fluorescent lamp. The graph 31 is divided into portions, wherein each portion corresponds to a respective zone A, B, C, D or E. Each zone comprises a group of LEDs. Each group of LEDs can be driven to provide a respective luminance level 32, 33, 34, 35 or 36. Hence, each respective luminance level 32, 33, 34, 35 or 36, corresponding to a respective zone A, B, C, D or E, provides a local approximation of the corresponding portion of the luminance profile of the lamp. Consequently, the luminance levels 32, 33, 34, 35 and 36 create an overall luminance profile, which approximates the continuous luminance profile of the lamp.

In FIG. 4, another example of how the backlight may be divided into zones is illustrated. Each row, R1, R2, R3, etc., is divided into a number of columns, and a column may comprise one or more LEDs. Each zone, which is addressed by means of specifying row and column, is associated with a respective LED group driver 1, 2 and 3 (all drivers are not shown). Between rows of LEDs R1, R2, R3, etc., fluorescent lamps 4, 5 are arranged. The fluorescent lamps may also be located on top of the LEDs (not shown). The fluorescent lamps 4 are in this particular example green and the fluorescent lamps 5 are blue. Alternatively, the lamps 4, 5 may be replaced by one fluorescent lamp, which is arranged to emit blue and green light. As can be seen in FIG. 4, the number of columns may differ from one row to another row, but other configurations, such as a fixed number of columns for each row are also possible to implement. With the division into zones according to this particular embodiment, one row of LEDs may be controlled to provide an overall luminance profile that match the luminance profile of one lamp 4, 5. The maximum number of zones is calculated as the maximum number of columns (zones) in one row (m) times the number of rows (n):

tₘₐₓ=m×n.

In FIG. 4, rows R1 and R2 are divided into five different zones, respectively, while row R3 is divided into seven different zones, each zone comprising one light source or a plurality of light sources. For full flexibility in matching e.g. the overall luminance profile of row R1 with the fluorescent lamp 4, each zone should be driven with its own driver, such that the luminance of a zone in row R1 can be adjusted independently of any other zone in row R1.

Referring to FIG. 5, the control electronics of the backlight according to an embodiment of the invention is demonstrated. FIG. 5 shows a lookup table T, a measure and control unit MC, a row dimming factor R, a column dimming factor C, feedback FBCK, a LED-group driver L-DR and LEDs L. The LED-group driver L-DR is connected to one zone. There are additional LED-group drivers for other zones, but these drivers are not shown. A dimming factor controlling the luminance of a zone, is controlled by the row-dimming factor R and the column-dimming factor C. The columns in a row have a common row-dimming factor and the actual luminance profile matching for that row is controlled by the column dimming factors of each respective column. Hence, the row dimming factor provides a base luminance level and the column dimming factors vary such as to provide a varying luminance level along the row, which luminance level matches a given luminance profile. The feedback FBCK is, in this example, a light sensor signal. Hence, when the backlight is placed in a dark room the luminance of the backlight is controlled by means of the signal from the light sensor to provide a higher luminance.

Each letter A-F in FIGS. 6-8 and 10-13 denotes one or more LEDs associated with a respective zone A-F, each zone being driven by a separate driver. R1, R2, R3 denote the first, second and third row. For reasons of simplicity, only three rows are illustrated.

In FIG. 6, there is shown an LED configuration of a backlight according to an embodiment of the invention. The backlight is divided into four vertical zones, each zone comprising LEDs A, B, C and D respectively. As shown in FIG. 4, fluorescent lamps may be arranged between the rows R1, R2, R3, etc. such that there are two HCFLs between row R1 and row R2, and two further HCFLs between row R2 and row R3. It is preferred to use red LEDs in combination with blue and green HCFLs. For simplicity, the HCFLs are not shown in FIG. 6. Again, in an alternative embodiment HCFLs, emitting blue and green light, are arranged between, on top of or under the LEDs. All LEDs A can be driven such that the luminance profile of the LEDs A locally match a corresponding portion of the luminance profile of the HCFLs. Similarly, the LEDs B, C and D can be driven such that their respective overall luminance profile locally match a portion of the luminance profile of the lamp that corresponds to each zone B, C and D. Hence, the overall luminance profile of the LEDs A, B, C and D approximates the continuous luminance profile of the HCFL in the horizontal direction.

FIG. 7 shows an LED configuration of a backlight according to another embodiment of the invention, in which the zones comprising LEDs A, B and C are arranged as concentric rectangles, which have rounded corners. Again, the HCFLs are omitted for simplicity. In this embodiment the luminance profile of the HCFLs is matched in the horizontal as well as the vertical direction.

In the following, a few examples of interspersion will be described. In FIG. 8 and FIG. 10 to FIG. 13, the underlined letters in the figures denote interspersed LEDs.

In FIG. 8, an interspersion of light sources is shown. The LED configuration shown in FIG. 8 is described and the HCFLs illustrated in FIG. 4 are not shown in FIG. 8. However, the HCFLs can be arranged as shown in FIG. 4. The backlight according to FIG. 8 comprises four zones, whereby a reduction of luminance differences, in the horizontal direction, between groups of LEDs A, B, C and D may be achieved. In row R1 a sequence of LEDs A are followed by a sequence of LEDs, in which every other light emitting diode is a LED A and every other light emitting diode is a LED B. This sequence of interspersed LEDs is, in its turn, followed by a sequence of LEDs B. As a consequence, the sequence of interspersed LEDs provide a luminance transition from the luminance of the LEDs A to the luminance of LEDs B (provided that luminance of LEDs A and B are different). If the luminance profile of an HCFL is symmetric a further reduction of the number of drivers can be obtained by connecting LEDs A and LEDs D to the same driver.

In FIG. 9, there is shown two graphs. The solid line graph represents a portion of a continuous luminance profile (e.g. according to FIG. 3) and the dashed line graph illustrates the luminance from the LEDs A and the LEDs B. The dotted line demonstrates a gradual luminance transition from luminance of LEDs A to luminance of LEDs B. In this manner, the differences in luminance between a first zone comprising LEDs A and a second zone comprising LEDs B is evened out.

Referring to FIG. 10, there is shown an interspersion strategy, in which the LED configuration is different for different rows R1, R2, R3, etc. The LEDs of row R2 are slightly displaced in relation to the LEDs of row R1. Further, the LEDs of row R3 are displaced in relation to the LEDs of row R2 and so forth. Hence, the LEDs are arranged diagonally over the display device backlight. As in the other examples, the HCFLs are not shown. This configuration is suitable if the luminance profiles of the HCFLs are different for different rows.

The embodiment of FIG. 11 is similar to that of FIG. 7 in that horizontal and vertical luminance defects are compensated for. However, in FIG. 11 interspersion is implemented such as to reduce luminance differences from LEDs of different zones.

FIG. 12 is yet a further example of interspersion. In this example, LEDs belonging to more than two zones are interspersed. In this embodiment, the sequence of interspersed LEDs comprises LEDs from as many as four different zones of LEDs A, B, C and D. By way of arranging the light sources in this manner, the luminance transition between zones may be made even smoother than in previously described embodiments. The degree of smoothing of the luminance transition depends on a number of factors, such as the spacing between the LEDs, the radiation profile of the individual LEDs and the overall optics employed in the display device backlight.

Obviously, a combination of the interspersion strategy in FIGS. 11 and 12 would yield yet a further example of interspersion.

Moreover, in FIG. 13, yet another example of interspersion is shown. In this example, LEDs from an arbitrary number of zones are interspersed in order to further smoothen the luminance transition from one zone to another. By combining a larger number of zones, a further reduction of the number of drivers needed may be achieved. This can be done by combining zones of two or more rows, but also by combining two zones in the same row. For example, A1 could be combined with F1, B1 with E1, and C1 with D1. This would create a symmetrical light distribution and less drivers per row would be needed.

In FIG. 14, there is shown an LED configuration, in which a hexagonal structure provides two-dimensional interspersion. A hexagonal structure may be provided by means of arranging the light sources in rows, which rows are arranged such that a first row is slightly displaced in relation to a second row following the first row. Further, a third row following the second row may be displaced in relation to the second row and so on. Columns of the third row are aligned with columns of the first row. Hence, two light sources of the first row, three light sources of the second row and two light sources of the third row may form a hexagonal structure. A minimum of three rows are required to create a hexagonal structure. In FIG. 14, the distribution for a single LED color is shown. The reference numerals 1-7 denote one zone, respectively (i.e. a total of seven zones), each zone having a substantially triangular shape. Due to the hexagonal structure, every LED has six neighbors, which advantageously enables an even light distribution.

In a further example, the backlight according to an embodiment of the invention comprises red, green and blue LEDs. The red LEDs are arranged according to a first LED configuration and the blue LEDs are arranged according to a second LED configuration, i.e. zones comprising red LEDs and zones comprising blue LEDs must not coincide. The green LEDs may, of course, be arranged according to a third LED configuration. Thus, zones comprising LEDs of different colors are independently arranged.

A man skilled in the art realizes that many other examples of interspersion of light sources may be implemented to provide an approximation of a luminance profile.

Even though the invention has been described with reference to specific exemplifying embodiments thereof, many different alterations, modifications and the like will become apparent for those skilled in the art. The described embodiments are therefore not intended to limit the scope of the invention, as defined by the appended claims.

1. A backlight for a display device comprising at least a first light source arrangement (1) and a second light source arrangement (2) and drivers (5, 6) for controlling said first and second light source arrangements (1, 2), said backlight comprising
a third light source arrangement (3), wherein
each of said first and second light source arrangements (1, 2) is controlled by a respective driver (5, 6) such that luminance of said first and second light source arrangements (1, 2) is individually controllable, wherein
each of said first and second light source arrangements (1, 2) is arranged such that luminance profile of said first and second arrangements (1, 2) is controlled to approximate at least a portion of a luminance profile of the third light source arrangement (3).

2. The backlight according to claim 1, wherein at least one light source (A, B, C, D) comprised in said first light source arrangement (1) is interspersed with light sources comprised in said second light source arrangement (2), whereby a gradual luminance transition from said first light source arrangement (1) to said second light source arrangement (2) is achieved, when said first light source arrangement (1) is arranged to have a different luminance than said second light source arrangement (2).

3. The backlight according to claim 2, wherein said at least one light source (A, B, C, D) is arranged to be located at the periphery of said first light source arrangement (1).

4. The backlight according to claim 1, wherein said backlight is divided into zones (A, B, C, D), said first light source arrangement (1) being arranged to correspond to a first zone (A) and said second light source arrangement (2) being arranged to correspond to a second zone (B).

5. The backlight according to claim 4, wherein said at least one light source (A, B, C, D) is physically located where a portion of said first zone (A) overlaps a portion of said second zone (B).

6. The backlight according to claim 4, wherein said first zone (A) is formed as a quadrangle and said second zone (B) is formed as a quadrangle that surrounds said first zone (A), and said second light source arrangement (2) is located outside the first zone (A), in the area enclosed by said quadrangle forming said second zone (B).

7. The backlight according to claim 1, wherein said third light source arrangement (3) has a spatial elongation and said first and second light source arrangements (1, 2) are aligned in a direction of the spatial elongation of said third light source arrangement (3).

8. The backlight according to claim 7, wherein a first light source set (81) comprises a row of light sources from said first light source arrangement (1), a second light source set (82) comprises a row of light sources from said second light source arrangement (2), and a third light source set (83) comprises a row of light sources of which every other light source is comprised in the first light source arrangement (1) and every other light source is comprised in the second light source arrangement (2).

9. The backlight according to claim 8, wherein the sets (81, 82, 83) of light sources are arranged along said direction of elongation.

10. The backlight according to claim 1, wherein said backlight is provided with a hexagonal structure (144) of light sources (1, 2, 3, 4, 5) said hexagonal structure (144) comprising at least a first light source row (141) being displaced in relation to a second light source row (142) located next to said first row (141), a third light source row (143) located next to the second row (142) being displaced in relation to the second row (142) and columns of said third row (143) being aligned with columns of light sources in said first row (141).

11. The backlight according to claim 10, wherein said first and second light source arrangements are arranged in triangular shapes.

12. The backlight according to claim 1, wherein said backlight comprises light emitting diodes.

13. The backlight according to claim 1, wherein said backlight comprises hot cathode fluorescent lamps.

14. A display device comprising the backlight according to claim 1 and a display panel for displaying a picture.

15. Driver means (5, 6) for a backlight of a display device, said driver means being arranged to control at least a first light source arrangement (1) and a second light source arrangement (2) of said backlight, such that luminance of said first and second light source arrangements (1, 2) is individually controllable and luminance profile of said first and second light source arrangements (1, 2) is controlled to approximate at least a portion of a luminance profile of a third light source arrangement (3).

16. The driver means according to claim 15, wherein said driver means are arranged to drive at least one light source (A, B, C, D), comprised in said first light source arrangement (1), said light source being interspersed with light sources comprised in said second light source arrangement (2), whereby a gradual luminance transition from said first light source arrangement (1) to said second light source arrangement (2) is achieved, when said driver means are arranged to drive said first light source arrangement (1) such that is has a different luminance than said second light source arrangement (2).

17. The driver means according to claim 15, wherein said driver means comprise a plurality of driver means arranged to control respective light source arrangements, whereby said backlight is divided into zones (A, B, C, D), such that a first driver is arranged to correspond to a first zone (A) and a second driver is arranged to correspond to a second zone (B).

18. A method of driving a backlight for a display device, comprising at least a first light source arrangement (1) and a second light source arrangement (2), said method comprising the step of:
individually controlling the luminance of said first and second light source arrangements (1, 2) such that luminance profile of said first and second arrangements (1, 2) is approximating at least a portion of a luminance profile of a third light source arrangement (3).
